(19) United States
(12) Patent Application Publication
(10) Pub. No.: US 2007/0060458 A1
(43) Pub. Date: Mar. 15, 2007

(54) Method for the manufacture of an hinge-lid box

(75) Inventors: Seppo Katajamaki, Tampere (FI); Lu Wentao, Aanekoski (JP)

Correspondence Address: BIRCH STEWART KOLASCH & BIRCH, PO BOX 747, FALLS CHURCH, VA, 22040-0747, US

(73) Assignee: M-real Oyj, Espoo (FI)

(21) Appl. No.: 10/553,354

(22) PCT Filed: Apr. 15, 2004
(86) PCT No.: PCT/FI04/00233

§ 371 Date: Jul. 25, 2006

(30) Foreign Application Priority Data
Apr. 16, 2003 (FI) 20030581

(51) Int. Cl. B31B 1/50

(52) U.S. Cl. 493/184

(57) ABSTRACT

The invention is related to hinge-lid boxes or containers for cigarettes, cigars, pastilles, sweets and other goods. The invention relates to a method for the manufacture of said hinge-lid boxes, particularly to a method for attaching of the collar to the packet portion. The method comprises steps wherein and the collar is glued to the packet portion of the hinge-lid box by applying the glue as horizontal uniform glue lines on the blank of the collar and/or horizontally on the respective area of the blank of the box part, which the collar will be attached to and the number of horizontal glue lines is at least two.

### FIELD OF TECHNOLOGY

The present invention is related to hinge-lid boxes or containers for cigarettes, cigars, cigarillos, pastilles, sweets and other goods. The invention relates to a method for the manufacture of said hinge-lid boxes, particularly to a method for attaching of the collar to the packet portion.

### STATE OF THE ART

Hinge-lid boxes are a form of packaging, which is commonly used for packaging of cigarettes, cigars and sweets. Hinge-lid boxes, also known as flip-top packages, are usually made of cardboard and they comprise a packet portion and a lid articulated on a box rear wall and a collar. The collar is anchored in the box part and has a collar front wall, collar sidewalls and optional collar back wall. The collar may be attached with lower fastening surfaces in the region of the collar front wall, collar side flaps and optional collar back wall to the inner side of the package. Hinge-lid boxes are generally manufactured from blanks comprising thin cardboard. In order to reduce the material and production costs, a hinge-lid box is often used, comprising a single all-in-one blank, wherein a collar or an inner frame, also called retainer or liner, may be connected to a main blank for the hinge-lid box. The hinge-lid box may also comprise a separate box-part blank and a collar part blank, which are glued together.

An example of a single all-in-one blank is described in U.S. Pat. No. 5,634,556. The collar is connected to a main blank in the region of folding tabs of the lid by adhesive bonding using glue spots.

A two-part blank for a flip-top container comprising an outer case forming portion and a liner portion is disclosed in GB 2,267,272. The collar is adhesively attached to the case-forming portion through a location panel hingedly connected to the collar using two vertical glue-lines on the front panel.

U.S. Pat. No. 5,462,223 discloses a process for coating glue-spot rows and strips onto longitudinally extending blanks for hinge-lid boxes. The glue-spots are applied by using glue nozzles of fixed location. The glue nozzles are designed for very high numbers of cycles so that, even at high working speed of the packaging machine and correspondingly high conveying speeds for the blanks, exact glue patterns can be transferred. Two parallel spot rows are applied to the inside of the front wall in order to fix the collar front wall.

A process for gluing packaging material, such as blanks or folding tabs of packs, during. the production of hinge-lid boxes for cigarettes, is disclosed in U.S. Pat. No. 6,409,646. Measures for reliable malfunction-free transfer of complex applications of glue to packaging materials with a packaging machine having a high output capacity are proposed. Accordingly, a hinge-lid box is configured, as far as the formation and an arrangement of applications of glue in the region of side walls and lid side walls are concerned, such that the outside tabs and lid side tabs are connected to another by narrow continuous strips of glue running in the longitudinal direction of said tabs and preferably by two parallel strips of glue in each case. The gluing of the lid part is carried out using glue spots.

According to prior art, glue spots, which are arranged in the region of the front wall of the package for fixing a collar formed from a separate blank as part of the hinged lid box, have been also disclosed. It has been proposed for spot-like applications of glue to be applied to the non-folded, that is to say planar blanks, from above by glue

nozzles producing spots of glue at selected positions by way of short spraying or injecting cycles. The application of glue in the region of the collar is designed such that the application of glue is constituted of glue spots or one glue line.

In the hinge-lid boxes according to the state of the art, the rigidity of package is not sufficient although the cardboard used in the manufacture is relatively thick. Glue spots or vertically arranged glue lines do not provide the box sufficient stiffness. The lid of the box may open, the box yields and sags easily especially when the box is not filled with the products or half empty and the products like cigarettes may be damaged and become useless. This problem has been solved by using thicker board. Thus there is an evident need for a method for the manufacture of light hinge-lid box with sufficient rigidity.

### OBJECT OF THE INVENTION

An object of the invention is to propose measures by means of which a collar or an inner frame, also called retainer or liner, can be affixed to the blank or frame board of a hinge-lid box.

A further object of the invention is to provide a more rigid and light hinge-lid box with improved deformation resistance capacity, which results in that the board basis weight can be reduced without losing package rigidity, and thus savings can be achieved in the board.

A further object of the invention is a method for the manufacture of hinge-lid boxes, particularly a method for gluing of the collar to the box portion of a hinge-lid container.

Characteristic features of the method according to the invention are presented in the claims.

### SUMMARY OF THE INVENTION

It has now been found that the above-identified objects can be achieved and the problems related to the solutions according to the state of the art can be avoided or at least substantially decreased by using the method according to the invention. The method for the manufacture of hinge-lid boxes comprises steps wherein glue is applied by horizontal line gluing on the blank of the collar on an area which remains covered in the finished box, and/or horizontally on the respective area of the blank of the box part, which the collar will be attached to and the number of horizontal glue lines is at least two and preferably three.

### BRIEF DESCRIPTION OF THE FIGURES

FIG. 1. The structure of a typical hinge-lid cigarette package is shown in FIG. 1.

FIG. 2. The dimensions of the package are shown in FIG. 2.

FIG. 3. FIG. 3 shows the mesh of the package used in the finite element analysis.

FIG. 4. Symmetric pressing on two side panels of the package is presented in FIG. 4.

FIG. 5. Side loading shear loading is shown in FIG. 5.

FIG. 6. The horizontal glue lines according to the invention are shown in FIG. 6.

FIG. 7. FIG. 7 shows the typical deformed shapes of the packages under symmetric loading with closed flip-top.

FIG. 8. FIG. 8 shows the typical deformed shapes of the packages under symmetric loading with opened flip-top.

FIG. 9. FIG. 9 shows the results of the finite element analysis for different ways of gluing the inframe (collar), closed flip-top.

FIG. 10. FIG. 10 shows the results of the finite element analysis for different ways of gluing the inframe (collar), opened flip-top.

FIG. 11. FIG. 11 shows the influence of basis weight, closed flip-top.

FIG. 12. FIG. 12 shows the influence of basis weight, opened flip-top.

FIG. 13. FIG. 13 presents the force resistance capacity, closed flip-top.

FIG. 14. FIG. 14 presents the force resistance capacity, opened flip-top.

### DETAILED DESCRIPTION OF THE INVENTION

According to the invention, by changing the size and geometry of the glued area, the rigidity of the hinge-lid boxes can be increased significantly, which results in that the board basis weight can be reduced without losing package rigidity. It was also found that the glue connection plays an important role in package rigidity. Package rigidity or deformation resistance capacity can be greatly increased by changing size and geometry of the glued area.

The method according to the invention, for the manufacture of hinge-lid boxes and particularly for gluing of the collar to the box portion of the hinge-lid container, comprises steps wherein glue is applied as uniform horizontal glue lines on the blank of the collar and/or horizontally on the respective area of the blank of the box part, which the collar will be attached to and the number of horizontal glue lines is at least two and preferably three. Preferably the glue lines are applied so that at least one glue line horizontally crosses the whole blank of the collar and at least one glue line crosses horizontally the lower part of the collar blank. The glue line may also be applied horizontally on the upper parts of the collar blank. According to one embodiment the glue lines may form a surface covering the whole area of the collar blank, which remains covered in the finished box. The geometry of the glued area is line or strip shape. Preferably the width of the glue line is at least 4 mm. Since the bending deformation is the most common deformation pattern, it is preferable to use strip-shaped glue area geometry and the orientation of the strips should follow the bow-shaped bending and nor perpendicular.

The gluing may be carried out using any gluing technique according to the state of the art, which suits for gluing of packages and boxes.

In the method according to the invention a hinge-lid box may be used comprising a single one piece blank or it may comprise two blanks, the other being the blank for the collar, or it may comprise more than two blanks. The form of the collar can be any conventional form or it may be V-shaped. The shape and design of the front part of the collar may vary, larger front part enables a larger glued area thus from its part improving the rigidity of the box. The blank of the collar part may also comprise a part, which partly or completely crosses the back wall of the box. The collar may optionally be printed and/or coated.

The blank(s) of the hinge-lid boxes are manufactured from board or paper and the collar may be manufactured from the same material as the box part or from thicker material when the collar and the box part are manufactured from separate blanks. According to the invention, thinner and lighter board can be used without losing the rigidity of the package. Depending on the design and structure, and deformation pattern under loading, the basis weight of the board or paper used for boxes, when compared with the currently used board with a thickness of 0.3 mm for cigarette boxes, can be reduced 20-30%, for example from 215 g/m² to 200 g/m².

According to the invention, a collar of a hinge-lid box is provided, which supports the front wall of the box and the rigidity of the box is clearly improved. Thus a steady beam like structure is achieved. The hinge-lid boxes, manufactured according to the invention, are light and sufficiently rigid and they have high deformation resistance capacity whereby the boxes retain their form even when they are almost empty, and the lid keeps tightly closed. The method makes it possible to use lighter grades of board, whereby savings can be made in raw material consumption resulting in source reduction.

The hinge-lid boxes manufactured with the method according to the invention may be used for packaging of cigarettes, cigars, cigarillos, pastilles, sweats and other goods in the form of granules or pills.

The invention is illustrated in the following example, however, to which the scope of the invention is not meant to be limited.

### EXAMPLES

### Example 1

An empty cigarette package, subjected to external forces, was simulated using finite element method. Structural analysis of the cigarette package was performed. The objective of the study was to examine the influence of the glue connection between the inframe and the package on package rigidity, and to find out whether by changing the size and geometry of the glued area it is possible to increase the rigidity of the package in order to reduce the board basis weight without loosing package rigidity. Experiments were also conducted on paperboard to measure the material properties and on cigarette packages to obtain the experimental data for comparison with the results from finite element analysis (FEA) [1-2], which provides a numerical tool for package structural analysis. A cigarette package was modelled in computer and its structure was studied. The deformation of the cigarette package subjected to external forces was calculated. The analysis provided a basis for judgement of the package “rigidity” and guidance for possible reduction of board basis weight.

It was found that the glue connection plays an important roll in package rigidity. The tests showed that the package rigidity or deformation resistance capacity could be greatly increased by changing the size and geometry of the glued area, and that there is a potential to lower the basis weight of paperboard without loosing package rigidity. Based on the results from the present analysis, the basis weight of a package can be reduced from 215 g/m² to 200 g/m².

Finite Element Analysis Model (FE Model)

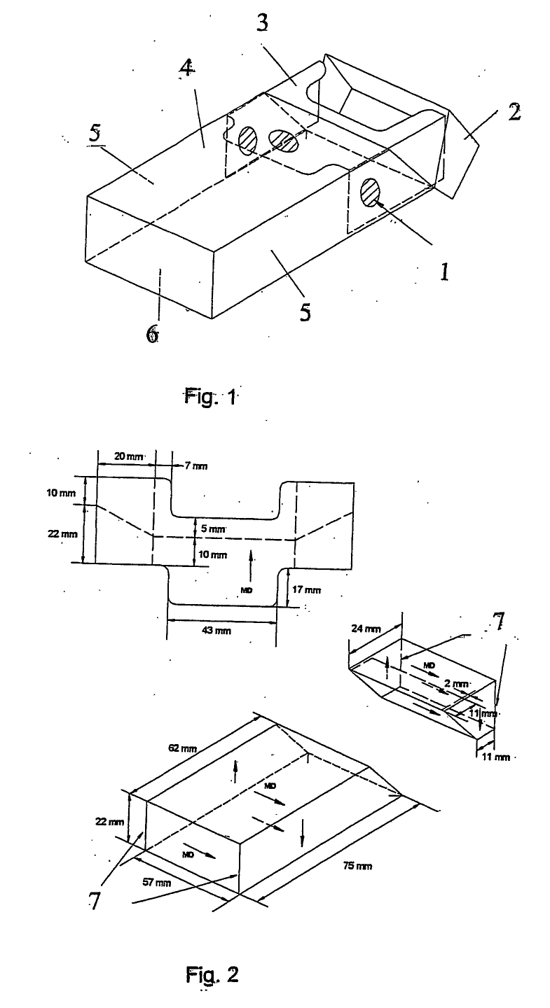

A commercial finite element analysis program MARC [3] was used. The structure of a cigarette package as shown in FIG. 1 was modelled wherein 1 presents a glue point, 2 fliptop, 3 inframe, 4 frontpanel, 5 sidepanels and 6 backpanel. The flip-top could be either opened or closed. The inframe was attached to the box (below the term “box” will be used for the package without inframe) by glue points. The dimensions of the package (not on scale) are shown in FIG. 2. The fiber orientation, i.e. the machine direction (MD) of the paperboard, is also shown in FIG. 2. The panels were jointed together with creased zones. Gaps 7 exist at certain edges as indicated in FIG. 2.

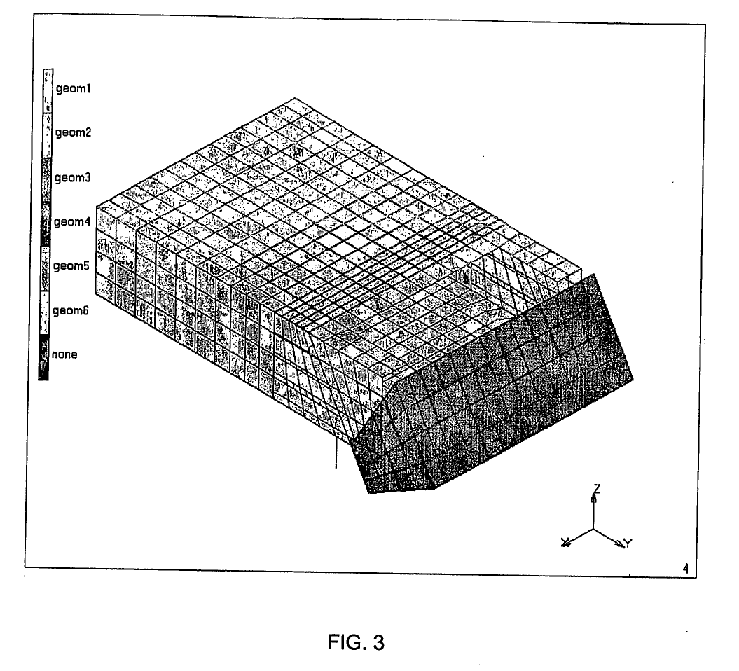

Eight-node thin shell elements were used. FIG. 3 shows the mesh of the package used in the finite element analysis (FEA). The material properties of the paperboard (orthotropic material) are listed in Table 1. The creases were incorporated in the model using rotational spring elements. The rotational stiffness of the creases was determined by folding tests. The glue points were modelled using the rigid link elements.

TABLE 1
Paperboard Mechanical Properties (Avanta Ultra)

| Properties | C | CX | C | X | C | CX |
|---|---|---|---|---|---|---|
| Grammage (g/m²) | 200 | 200 | 215 | 215 | 230 | 230 |
| Thickness (μm) | 265 | 275 | 300 | 305 | 325 | 325 |
| Young's Modulus | 6150 | 6350 | 5650 | 6450 | 5410 | 6110 |
| MD (N/mm²) | | | | | | |
| Young's Modulus | 3070 | 2670 | 2760 | 2560 | 2870 | 2510 |
| CD (N/mm²) | | | | | | |
| Shear Modulus | 1680 | 1590 | 1530 | 1570 | 1520 | 1520 |
| (N/mm²) | | | | | | |
| Poisson's ratio | 0.3 | 0.3 | 0.3 | 0.3 | 0.3 | 0.3 |
| Crease Stiffness | 0.1005 | 0.1005 | 0.1250 | 0.1250 | 0.1314 | 0.1314 |
| (N · mm/rad · mm) | | | | | | |

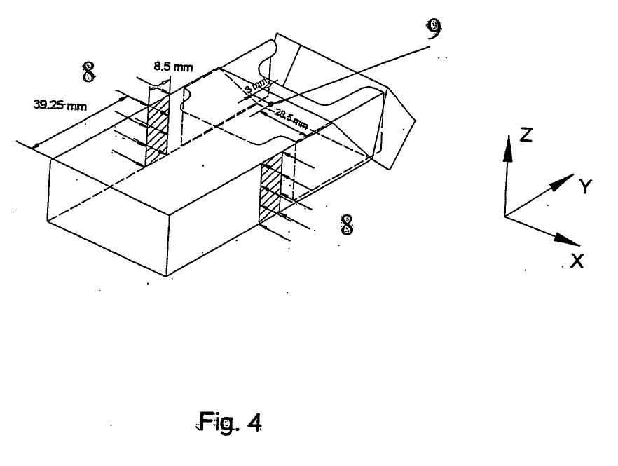

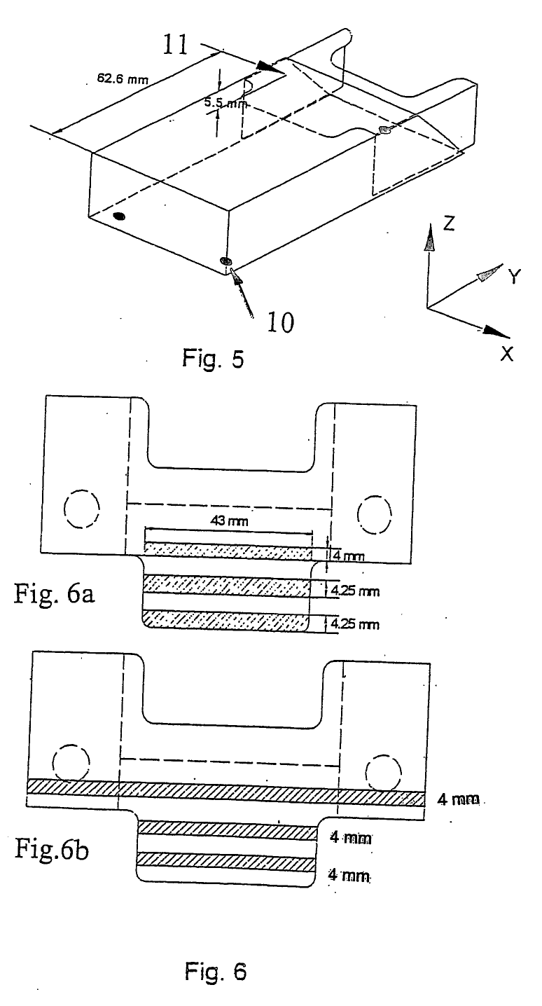

Two different boundary and loading conditions were considered in the analysis:
a. Symmetric pressing on the two sidepanels, shown in FIG. 4, wherein 8 represents pressure loadings and 9 displacement output mode. This loading case was a simplified simulation of holding a cigarette package in a hand and squeezing it. The package was pressed on both sidepanels. The pressure load was applied on the shaded area in FIG. 4. The package was constrained according to symmetric conditions. Opened and closed flip-top packages were considered.
b. Side loading (shear loading) is presented in FIG. 5, wherein 10 represents fixed point and 11 point load.

In this case the focus was on the influence of crease stiffness on package rigidity. In order to expose the effect of crease stiffness, the flip-top was not considered (FIG. 5). The package was fixed (zero displacement and rotation) at three points on the backpanel. A point load was applied on one sidepanel.

Because of the thin flexible nature of the panels, and associated large deflections of the panels, geometrically nonlinear analysis was performed. For the package with closed flip-top under symmetric loading, the contact and relative movement (sliding) between the inframe and the flip-top was modelled using contact elements. The material was considered as linear.

The front- and backpanel of the packages are usually not perfectly flat and almost always have certain curvatures, although they are usually very small. These small initial curvatures are very important in the structure analysis for the symmetric pressing case. They were incorporated by applying first small initial perturbation forces on the front- and backpanel of the packages.

Package Rigidity and Size and Geometry of Glued Area

The inframe is conventionally glued to the box at three points as can be seen from FIG. 1. The glued area can be considered as a circle of about 10 mm in diameter. In the analysis, the round-glued area was approximated by the quadrilateral elements.

Two modified glue cases were considered. According to the invention the glue point between inframe and frontpanel was changed to 3 glue lines. The size and geometry as well as length and width of the glue lines are shown in an embodiment in FIG. 6a. In FIG. 6b is shown another embodiment according to the invention wherein the first glue line crosses horizontally the whole collar part and the third glue line crosses horizontally the lower section of the collar. The inframe is glued fully to the box.

Results of analysis for symmetric pressing:

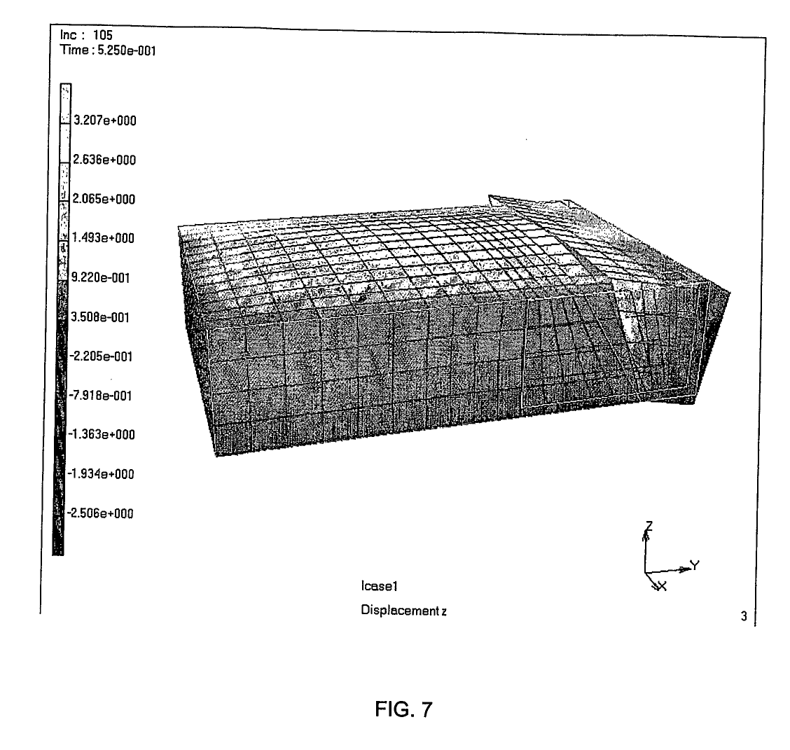

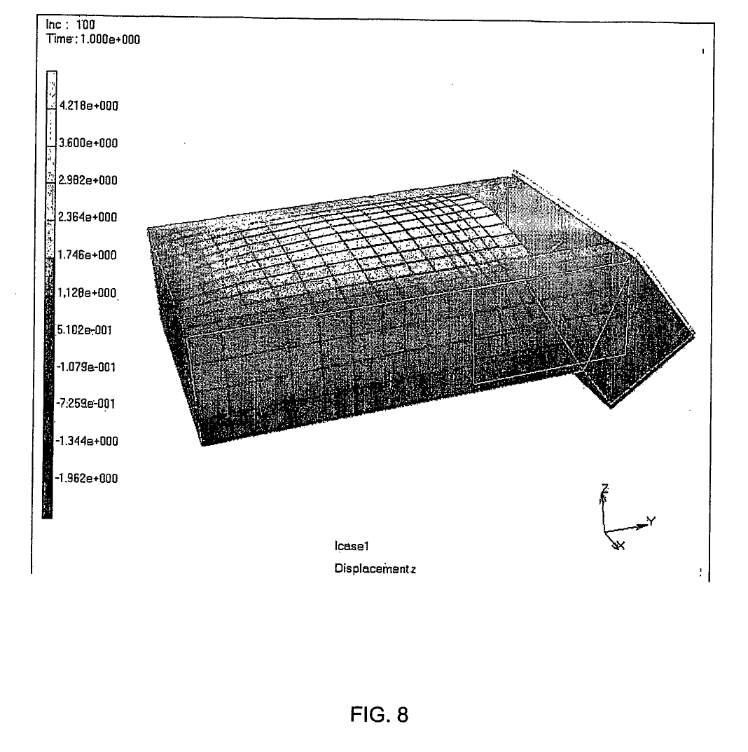

FIGS. 7 (deformed package, closed fliptop) and 8 (deformed package, opened fliptop) show the typical deformed shapes of the packages under the same symmetric loading with closed and opened flip-top, respectively. For the package with closed flip-top, the flip-top would slide open as the applied load increases. The calculation stopped when inframe is pop-out. Further calculation to capture this sudden shape change needs small load increments and long calculation time (which was not considered in the present study). For the package with opened flip-top, the calculation stopped when the deformation becomes too large, i.e. the maximum displacement on the frontpanel is over about 8 mm. In order to characterize the deformation of the package, the displacement of a point on the frontpanel as shown in FIG. 4 (near the maximum displacement point of the frontpanel) is used.

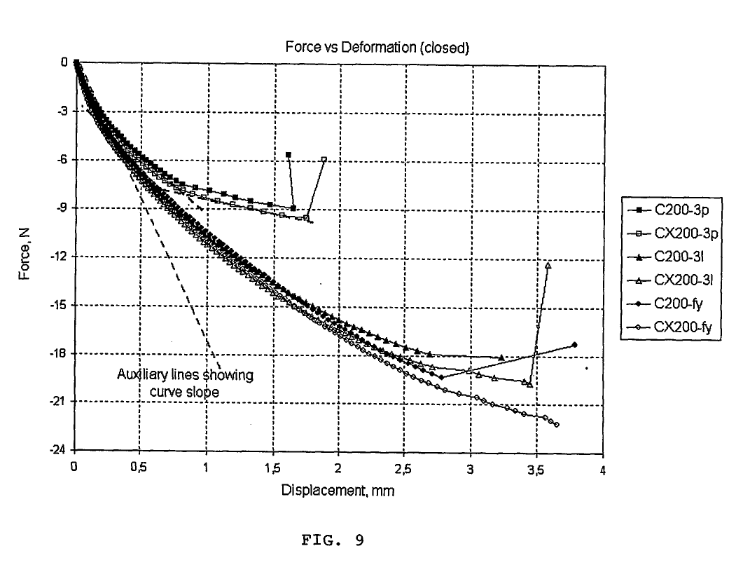

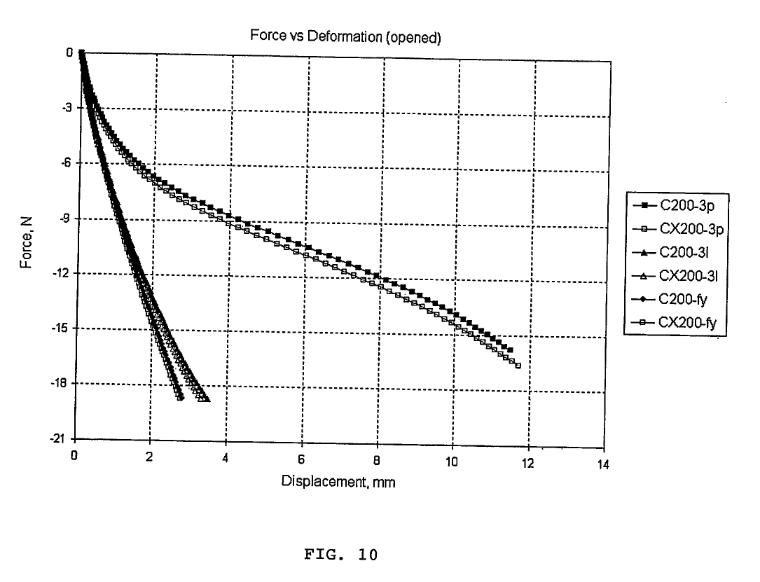

FIGS. 9 (influence of glued area, closed fliptop) and 10 (influence of glued area, opened fliptop) show the results of the finite element analysis for different ways of gluing the inframe. The total applied force (y-axis) on one side panel was calculated by the product of the pressure and the pressure applied area. The displacement of the point on the frontpanel (FIG. 4) used to characterize the package deformation was calculated in the analysis and is shown in x-axis. Two board materials, Avanta Ultra C200 and CX200, were used. “p” is for the 3-point glued inframe, and “3l for the 3-line glued inframe, “fy” for the fully glued inframe. The dash lines in the figures are auxiliary lines showing the slope of the force and displacement curve representing the package rigidity.

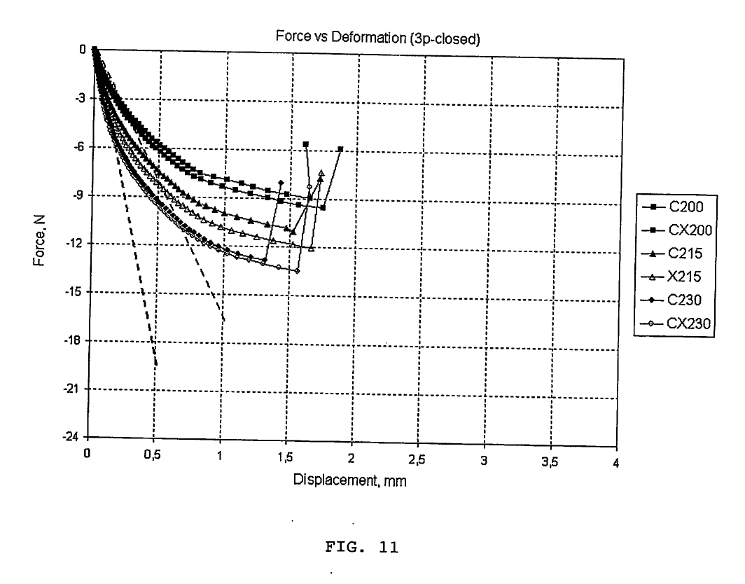

As expected, the package rigidity is increased by the 3-line and fully glued inframe. The increase of the package rigidity is more for opened flip-top (FIG. 10) than for closed fliptop (FIG. 9). This is a reasonable result, because the strengthen effect of the frontpanel by the inframe is exposed in the case of the opened fliptop. The package deformation resistance capacity has increased very much by changing the way of inframe gluing. Take FIG. 9 for example, for the package with 3-point glued inframe the rigidity decreases very much when the displacement is larger than 0.75 mm (curve slope change showed by the dash lines). However, the packages with 3-line and fully glued inframes are much stiffer when the displacement is over 0.75 mm. There is very little difference between the 3-line and fully glued inframe. This indicates that there is an optimal way to glue the inframe to obtain the maximum rigidity increase of the package. The influence of the difference between the board material Avanta Ultra C and CX was very small.

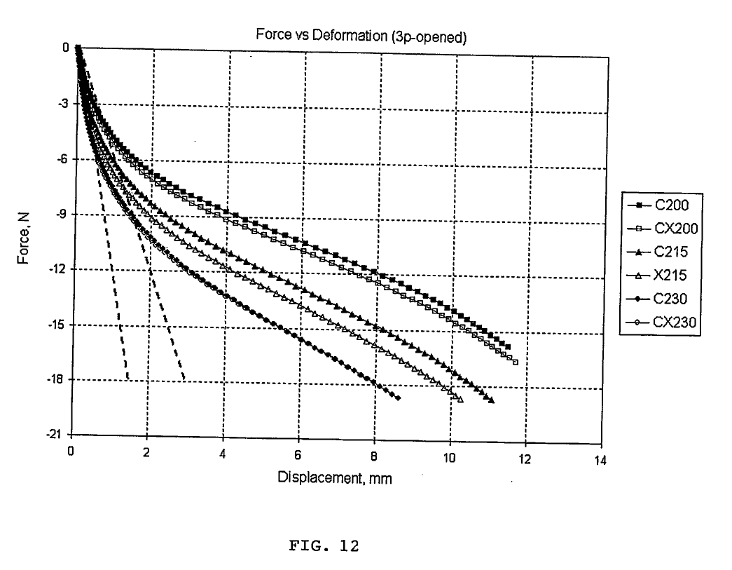

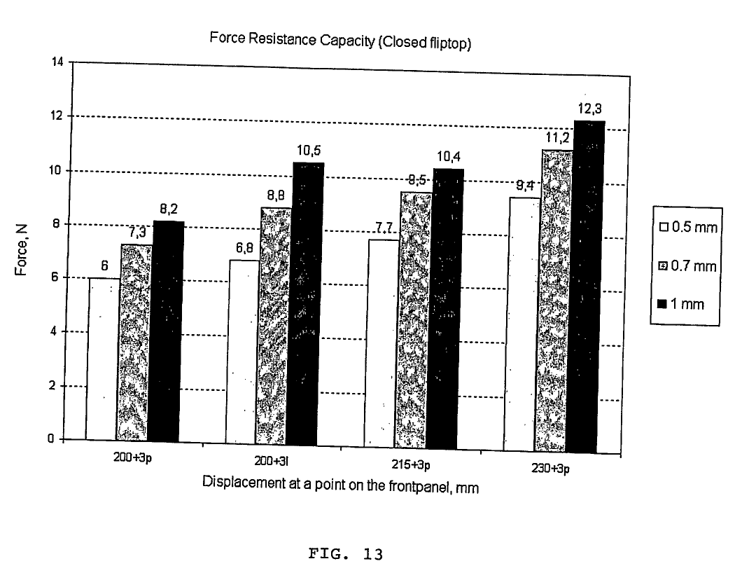

FIGS. 11 (influence of basis weight, closed fliptop) and 12 (influence of basis weight, opened fliptop) show the results for different board basis weights. The inframe in these packages was glued to the box at 3 points. The dash lines in the figures are auxiliary lines showing the initial rigidity of the packages. As expected, the package rigidity increases with increasing board basis weight. Increased basis. weight effects the rigidity mostly at small deformation (All curves for different basis weight have a similar shape). In closed flip-top containers, increasing basis weight showed a little stronger effect on the package rigidity than changing of the way of inframe gluing at small deformation (FIG. 9 and 11). For packages with opened flip-top, the rigidity at small deformation was almost the same for the packages with 3-line and fully glued inframes (FIG. 10) as for the packages with the increased basis weight of 230 g/m² (FIG. 12). At large deformation the packages with 3-line and fully glued inframes are much stronger, while the increasing of basis weight has very little effect.

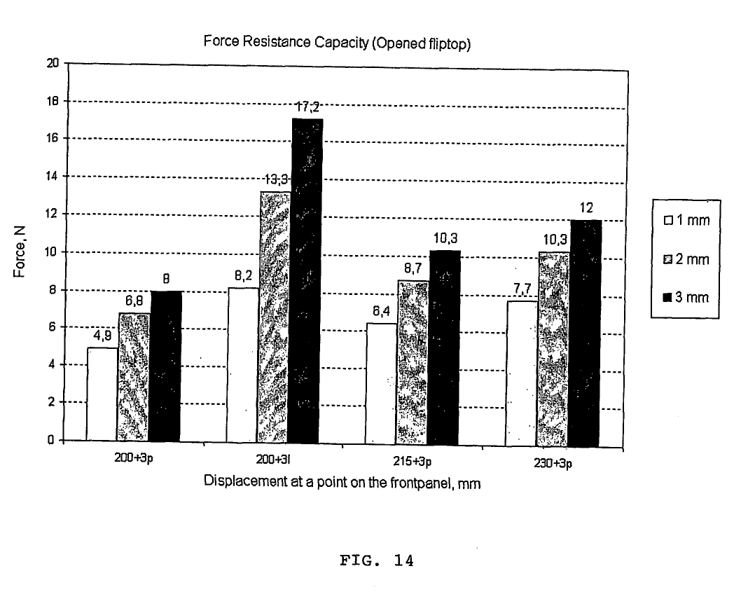

FIG. 13 (force resistance capacity, closed fliptop) and 14 (force resistance capacity, opened fliptop) show the resistance force at a certain displacement of the point on the frontpanel (FIG. 4). In the figures, “200+3p”, “215+3p” and “230+3p” represent the packages with basis weight of 200, 215 and 230 g/m², respectively, and 3-point glued inframes. “200+31” is the package with basis weight of 200 g/m² and 3-line glued inframe. For packages with closed flip-top (FIG. 13), it seems that the rigidity of the packages is not influenced very much by the way of inframe gluing. It is more dependent on the basis weight of the packages because of the locking effect of the fliptop. FIG. 13 shows that at small displacement (0.5 and 0.75 mm) the package with basis weight of 200 g/m² and 3-line glued inframe (200+31) is not as rigid as the packages with basis weight of 215 and 230 g/m² and 3-point glued inframe (215+3p and 230+3p). When the displacement increases to 1 mm, the rigidity of the package with basis weight of 200 g/m² and 3-line glued inframe (200+31) can match the rigidity of the packages of 215 g/m² and 3-point glued inframe (215+3p).

For packages with opened fliptop (FIG. 14), the rigidity of the packages is increased very much by changing the way of inframe gluing. Unlike the packages with closed fliptops, the rigidity increase can be seen at both samll and large displacement. This indicates that the strengthen effect of gluing plays a key role when the fliptop is opened.

The above analysis indicates that it is possible to reduce the basis weight from 215 to 200 g/m² while keeping the package rigidity by changing the way of inframe gluing.

### REFERENCES

1. T. R. Chandrupatla and A. D. Belegumdu, Introduction of Finite Elements in Engineering, Prentice Hall, Englewood Cliffs, New Jersey, 1991
2. O. C. Zienkiewicz, The Finite Element Method, Third Edition, McGraw-Hill Publishing Company, 1979
3. MARC Theory and User Information, Volume A, Version K7, MARC Analysis Research Corporation, Palo Alto, Calif., 1997
4. G. A. Baum, D. C. Brennan and C. C. Habeger, Orthotropic Elastic Constants of Paper, TAPPI J., Vol. 64, No. 8, 1981, pp 97-101

1. A method for the manufacture of a hinge-lid box, characterized in, that the method comprises steps wherein the collar is glued to the packet portion of the hinge-lid box, the hinge-lid box comprising two blanks or more than two blanks, the other being the blank for the collar, by applying the glue as horizontal uniform glue lines on the blank of the collar and/or horizontally on the respective area of the blank of the box part, which the collar will be attached to, the glue lines being applied so that at least one glue line horizontally crosses the whole blank of the collar, and the number of horizontal glue lines is at least two.

2. A method according to claim 1 for the manufacture of a hinge-lid box, characterized in, that the number of glue lines is at least three.

3. A method according to claim 1, characterized in, that at least one glue line crosses horizontally the lower part of the collar blank and the geometry of the glued area is line or strip shape.

4. A method according to claim 1, characterized in, that the glue lines form a uniform surface covering the whole area of the collar blank, which remains covered in the finished box.

5. A method according to claim 1, characterized in, that the collar is printed and/or coated.

6. A method for gluing of the collar to the box portion of a hinge-lid box, characterized in, that the method comprises steps wherein the glue is applied as horizontal uniform glue lines on a blank of the collar and/or horizontally on the respective area of the blank of the box part, which the collar will be attached to, the hinge-lid box comprising two blanks and the other being the blank for the collar, or more than two blanks, the glue lines being applied so that at least one glue line horizontally crosses the whole blank of the collar and the number of horizontal glue lines is at least two.

7. A method according to claim 6 for gluing of the collar to the packet portion of the hinge-lid box, characterized in, that the number of glue lines is at least three.

8. A method according to claim 6, characterized in, that at least one glue line crosses horizontally the lower part of the collar blank and the geometry of the glued area is line or strip shape.

9. A method according to claim 6, characterized in, that the glue lines form a uniform surface covering the whole area of the collar blank, which remains covered in the finished box.

10. A method according to claim 6, characterized in, that the collar is printed and/or coated.

11. A method according to claim 2, characterized in, that at least one glue line crosses horizontally the lower part of the collar blank and the geometry of the glued area is line or strip shape.

12. A method according to claim 2, characterized in, that the glue lines form a uniform surface covering the whole area of the collar blank, which remains covered in the finished box.

13. A method according to claim 3, characterized in, that the glue lines form a uniform surface covering the whole area of the collar blank, which remains covered in the finished box.

14. A method according to claim 2, characterized in, that the collar is printed and/or coated.

15. A method according to claim 3, characterized in, that the collar is printed and/or coated.

16. A method according to claim 4, characterized in, that the collar is printed and/or coated.

17. A method according to claim 7, characterized in, that at least one glue line crosses horizontally the lower part of the collar blank and the geometry of the glued area is line or strip shape.

18. A method according to claim 7, characterized in, that the glue lines form a uniform surface covering the whole area of the collar blank, which remains covered in the finished box.

19. A method according to claim 8, characterized in, that the glue lines form a uniform surface covering the whole area of the collar blank, which remains covered in the finished box.

20. A method according to claim 7, characterized in, that the collar is printed and/or coated.
